(19) United States
(12) Patent Application Publication
(10) Pub. No.: US 2006/0032905 A1
(43) Pub. Date: Feb. 16, 2006

(54) Smart card network interface device

(76) Inventors: Alon Bear, Haifa (IL); Dror Zernik, Haifa (IL)

Correspondence Address: Daniel J Swirsky;Alphapatent Associates, P O Box 2345, Beit Shemesh, 99544, IL

(21) Appl. No.: 10/518,095

(22) PCT Filed: Jun. 13, 2003
(86) PCT No.: PCT/IL03/00525

§ 371 Date: Jul. 12, 2005

Related U.S. Application Data
(60) Provisional application No. 60/389,499, filed on Jun. 19, 2002.

(51) Int. Cl. G06K 5/00

(52) U.S. Cl. 235/380

(57) ABSTRACT

A smart card device is provided which may be directly hooked to a network or Internet via a phone or other communication interfaces. The smart card device includes a smart card reader and a communications interface, such as a MODEM, (54) an infra-red interface, RF, tone, or an Ethernet interface, and a minimal device controller. (52) A system and method for remotely verifying the identification (authentication) of the user of a smart card are also provided, and for completing the remote transaction. The invention supports two key functions (remote authentication and remote secure transaction) which can be carried out while the communication is not interrupted, and specifically (in the case of the telephone) while the call is in progress.

### FIELD OF THE INVENTION

The present invention relates to the field of smart cards in general and in particular to a stand-alone device for reading smart cards and transmitting information therefrom.

### BACKGROUND OF THE INVENTION

Currently available smart card readers are typically integrated into computers or configured as computer peripheral equipment, connected to the serial port of a personal computer, for example. Smart card readers may also be integrated with cellular phone or set-top-boxes (TV), or built into other equipment such as bank terminals, and keyboards, for example. Generally, the host appliance, whether a computer, a cellular phone, or a Set-Top-Box, is responsible for providing the network interface. Normally smart card readers rely on the host device to provide standard input-output (I/O) interface for the human-user on top of the network connectivity. The necessity of a host device limits the scope of smart card applications. For example, at present each cashier with each merchant site requires its own host device, such as a PC or a Point of Sale (POS) device, in order to read a card and if necessary interface with the central computer system.

Cellular phones may use the SIM chip of the phone itself as a smart card, but this usage is limited to a specific application and does not allow for general-purpose smart card access. Alternatively, a standard-size smart card reader may be integrated with the (cellular) phone. In the latter case, the reader is dependent on specific properties of the device or on the cellular service provider and therefore it is third party dependent. The phone needs to be programmed to recognize each specific card in use, or alternatively the approval of cellular telephone operator is required.

Set-top-box applications are limited to a communicating via a unique server, for a specific card (the cable-operator card, or other pre-set cards), and human-interface is through the TV.

There is thus a need for a stand-alone device which does not need a separate host device, or be integrated in a host device, such as a computer, a POS, or a cellular phone, for example, and which allows any standard card to establish a communication with the appropriate server, to implement the desired smart card applications.

### SUMMARY OF THE INVENTION

The present invention is directed to a stand-alone device for reading and writing smart cards, which incorporates its own processing and network interface. The device may be integrated into a telephone or other network-accessing device, which can capture the network connectivity. Furthermore, the general-purpose device allows for access for any card application for any smart card. Even when integrated into telephones (cellular or landline), for example, the device does not have to rely on specific telephone properties nor on the service provider, but rather it provides a general-purpose network access over telephone, or any other network media.

The computing power of the card is used for handling the required application layers, while the computing on the device is used only for network interfacing. The device provides communication interfaces allowing the smart card to be exploited in its full potential, utilizing the security capabilities of the smart card, and supporting authentication using the (optional) PIN (Personal Identification Number). Input and output for the user may be provided through either the telephone, or optionally, an on-device display and keyboard.

In an embodiment of the present invention, there is provided a device, which includes a smart card reader and a communications interface, and a controller that transfers data between these two interfaces. The communications interface may be at least one interface including MODEM, infra-red (IR), Ethernet, radio frequency (RF), audio tones or any other communication media, coupled to the smart card reader.

In a further embodiment of the present invention, there is provided a system for remotely verifying the identification (authentication) of the user of a smart card. The system includes the smart card device of the invention and a remotely located server in communication with the communications interface, the server having means for verifying the validity of the smart card being read by the smart card device, and other data keyed into the device. The remotely located server may further comprise means for validating a certificate or means for generating a challenge that is then authenticated by the appropriate response from the device. The remotely located server may further comprise means for transferring e-goods or e-money.

Furthermore, the smart card device may be configured to be connectable between a telephone and the wall socket of a telephone line or to a cellular telephone.

Furthermore, the communications interface may include at least one of a group including a MODEM, Ethernet, infra-red (IR), RF and audio tones.

Furthermore, the smart card device may include a display screen and a numeric and/or functions keypad. The device may also include encryption means and a connector for external devices. The external devices may include a printer, a keypad and a biometric data reader.

Furthermore, the power source may include at least one energy source from a group including an internal battery, an external power inlet, the communication media to which the device is coupled and a rechargeable battery.

Furthermore, the smart card device may include at least one of a group including a printer, a keypad and a biometric data reader integrated within the device. The smart card device may further include at least one of a group of processing components including a additional computation capabilities, additional communication interfaces and additional encryption capabilities.

Furthermore, the smart card reader may include at least one memory component including Read Only Memory (ROM), Non-Volatile Memory (NVM) and Random Access Memory (RAM).

In another embodiment of the present invention, there is provided a method for verifying the identification of the remote user of a smart card, the method including the steps of inserting a smart card into a smart card device of the invention, transmitting data to and from the smart card, via the communications interface, to a remotely located server, the remotely located server transferring transaction information to the smart card device for approval, inputting privately known information into the smart card device and transmitting the proof of signature (certificate) to the remotely located server, and the remotely located server verifying that the privately known information is the valid one for the card.

In another embodiment of the present invention, there is provided a method for remotely purchasing goods or services, the method including the steps of inserting a smart card into a smart card device of the invention, selecting an item to be purchased from a supplier, transmitting data read from the smart card, via the communications interface, to a remotely located server in communication with the supplier, the remotely located server transferring transaction information associated with the purchase to the smart card device for approval, and storing the transaction information in the smart card.

Furthermore, the method may include the step of authenticating the identity of the smart card user. The step of authenticating may include the steps of inputting privately known information, the smart card verifying that the privately known information matches the smart card data, and generating a certificate validating the transaction.

Furthermore, the step of authenticating may be performed by the remotely located server.

Furthermore, the transaction may involve e-goods, which can then be stored on the card itself, for a later use.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 is a schematic illustration of a prior art example of an operational environment for use with smart cards;

FIG. 2 is a schematic illustration of a smart card device constructed and operative according to an embodiment of the invention;

FIG. 2a is a schematic illustration of the smart card device of FIG. 2 hooked on to a standard telephone;

FIG. 3 is a schematic illustration of a smart card device, of FIG. 2 hooked on to a cellular telephone;

FIG. 4 is a flow chart illustration of the use of the smart card device of FIG. 2;

FIG. 5 is a schematic illustration of a smart card device, according to another embodiment of the invention; and

FIG. 6 is a flow chart illustration of a further use of the smart card device of FIG. 2.

### DETAILED DESCRIPTION OF PREFERRED EMBODIMENTS

Reference is now made to FIG. 1, which is a schematic illustration of a prior art example of an operational environment for use with smart cards.

In the configuration of FIG. 1, a smart card 12, which may be inserted in a smart card reader 14 is in communication with a host device, such as personal computer (PC) 16. Communication between the card reader 14 and the host device 16 may be via any peripheral-device to PC communication interface, for example an RS-232 communication interface 18. A MODEM 20 is connected to host device 16.

Data is read from the smart card 12 by smart card reader 14 and transferred via the peripheral-device to communication interface 18. The Host device 16 manages the interactions with the card, and when desired it transfers information from and to host device 16 to and from the card 12. To transfer data onwards, the modem 20 may communicate with a remote server 22 via the Internet 24, using any Internet protocol, such as HTTP, for example, or secured protocols if desired. In a similar prior-art configuration, the reader may be hooked to the cellular phone, which serves as a host, and caries much of the application's logic.

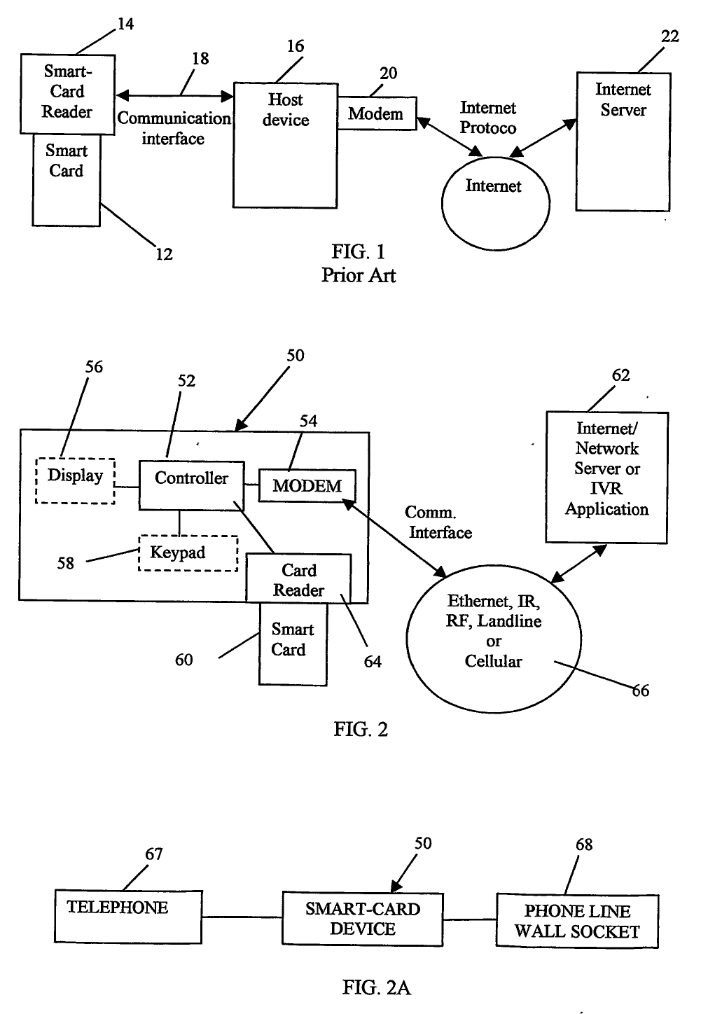

Reference is now made to FIG. 2, which is a schematic illustration of a smart card device, generally designated 50, according to an embodiment of the invention.

Smart card device 50 comprises a device controller 52 connected to a smart card reader 64 and a MODEM 54. It will be appreciated by persons knowledgeable in the art that the MODEM may be replaced by any other network interface component, such as Bluetooth, I-R, or Ethernet as examples. The controller 52 may comprise minimal processing capabilities, such as transferring and correctly packaging one communications protocol to another in order to control any of the embodied devices. The memory may include Read Only Memory (ROM), Non-Volatile Memory (NVM) and Random Access Memory (RAM), for example. A smart card reader 64 is connected to controller 52.

In a further embodiment of the invention, smart card device 50 may further comprise a display 56 and minima keypad having at least one key 58, or ports for attaching external equipment, such as an external keypad (not shown), or a printer.

In yet additional embodiments of the invention, the device may contain an encryption device such as a SIM.

In yet additional embodiments of the invention, the device may contain a battery or an external power source. Alternatively, the specific communication media, to which the device is attached, may provide the power supply for the device, or power may be supplied from a combination of the above sources.

The smart card device 50 is configured to dial or hook into any network 66, such as a telephone network, for example, and complete a two-way protocol, with the server 62. The server 62 may be any suitable network server, such as an Internet server, or an Interactive Voice Response server (IVR), depending on the desired network in use. In this embodiment, data is read from the smart card 60 by smart card reader 64 and transferred via MODEM 54 using voice-MODEM protocol, for example, to IVR Server 62.

In an exemplary embodiment, illustrated in FIG. 2a, the smart card device 50 may be coupled between a telephone instrument 67 and the wall-socket of the telephone line 68.

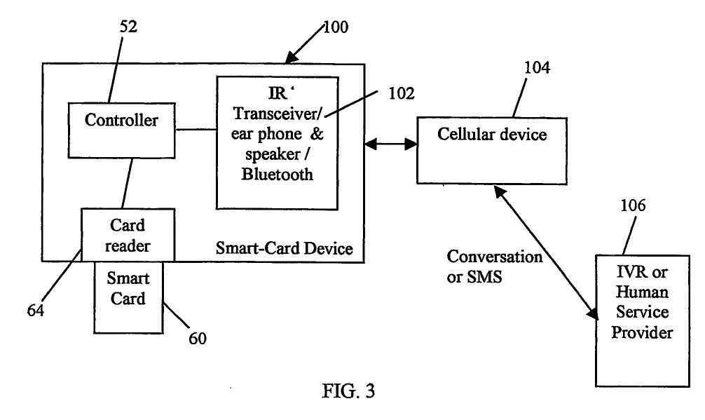

Similarly, in an exemplary embodiment, illustrated in FIG. 3, a smart card device, generally designated 100 may be connected to a transceiver, such as a cellular telephone 104, via any of the cellular telephone interfaces (such as, IR, ear-phone-speaker, or Bluetooth), and provide all the required access functions to a remote server 106. The remote server 106 may be an IVR or human service provider, or an SMS server.

Smart card device 100 comprises a controller 52 connected to a smart card reader 64 (similar to the reader of FIG. 2) and coupled to an infra-red (IR) transceiver 102, or any other interface capable of being supported by cellular phones.

In the embodiment of FIG. 3, the device 100 transmits and receives the data read by smart card reader 64 via the IR transceiver 102 to an IR transceiver located within the cellular device 104, which may then act as a device controller for a specific application. For example, IR receiver 104 may cause the cellular phone to transmit authentication data read from the smart card 60 to remote server 106, using any of the cellular phone channels. After secure identification of the user and verification that ID matches the data from the smart card, the server 106 may authorize the cellular phone 104 to interact with another external device and perform a requested/authorized action, or alternatively, the server may directly instruct the device to provide the requested access. This example is illustrative of the use of a smart card device of the present invention for building low-cost “gate-keepers” based on cellular connectivity and smart card authentication capabilities.

In an alternative embodiment, the IR transceiver within the cellular phone 104 may allow the telephone's display and keyboard to be used. The cellular phone may be used for full human dialogue with the server 106.

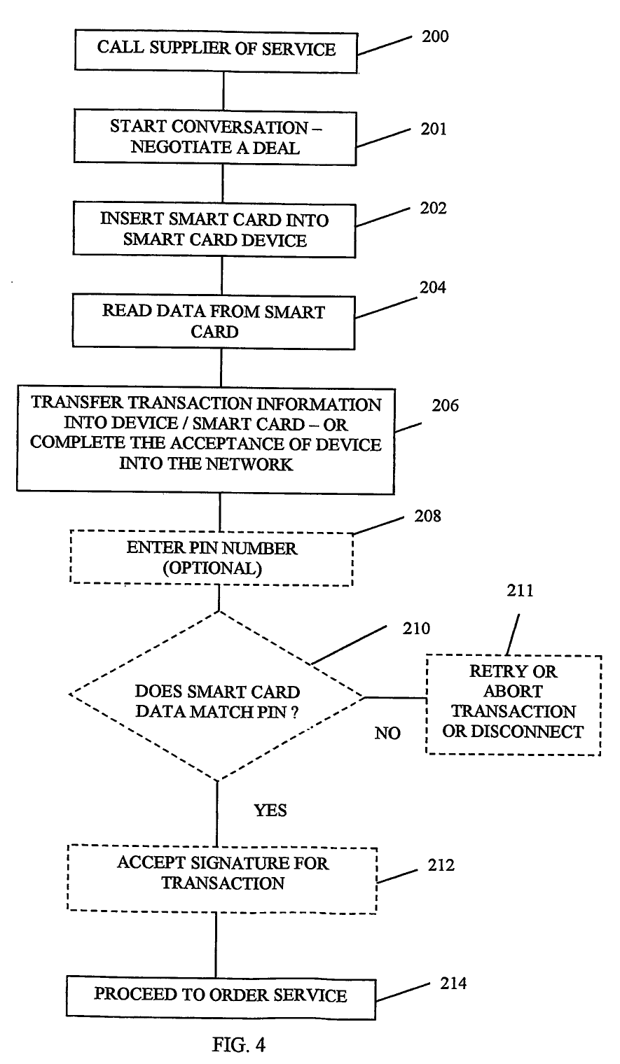

The operation of the smart card device may be described with reference to the flow chart of FIG. 4, to which reference is now made. The user establishes communication with the server of the service supplier (step 200). Communication may be established by dialing from a phone, as shown in the embodiment of FIG. 2, or by hooking to the LAN, or by any other mean of joining the requested network. A transaction (deal) is negotiated (step 201) or a service purchased or requested.

The smart card may be required either in order to complete the acceptance of the device into the network, in which case a handshake may be required, or alternatively, the smart card may be required just for performing the desired transaction. The smart card 60 is inserted into the smart card device 50 (step 202), which reads the information on the smart card (step 204). Alternatively, some networks may require that the card be inserted before goods or a service is purchased. After the smart card is inserted, the MODEM changes from voice mode to data mode, as is known in the art, so as to allow data to be transferred. Alternatively, the network interface may select the appropriate transactional state.

In the prior art, user identity is generally authenticated in the following manner: First, the user “identifies” himself, for example by stating his name (or by reading the open information on the card). Secondly, the user may be requested to show the card: ownership of the card is perceived as a proof of identity. Since cards maybe lost, stolen, or copied—an additional proof is often required. This proof may consist of a PIN or secret information (such as the maiden name of the card holder's mother), or by biometric information, which typically cannot be given to others, or a combination thereof.

In an embodiment of the invention, the user's ownership of the card is proven by the insertion of the card into the device; the identity may be further authenticated by transferring the smart card information to the service provider, and/or by using additional mean like PIN and/or biometric identification.

The PIN may be keyed on a keyboard that forms an integral part of the device, an external keyboard or the telephone keyboard. Biometric data (such as fingerprint, voice signature, iris pattern, hand palm, etc.) may be obtained using a biometric reader, integrated in the device, or by external means, as is known in the art.

The PIN and/or biometric data may be sent to the service provider (or to mediator card manager) as is, encrypted, or authenticated in the smart card itself. In the latter case the authentication certificate is sent to the service provider, which may validate the certificate, as is known in the art. When encrypted for sending, the device may use the integrated SIM for encryption, or use the encryption engine of the smart card itself, when possible.

Typically, besides the need to identify the user/customer, the merchant or service provider needs to obtain proof of the existence of the transaction, and its details. At present, this confirmation is obtained either by having the customer sign a piece of paper where the transaction data is recorded, or by generating a digital signature. In an embodiment of the invention, confirmation may be obtained as follows:

The transaction information may be transferred to the device 50 for the user's to review and/or to confirm and possibly also to store on the card.

Confirmation may be obtained by keying a confirmation key (of the device, external, or the telephone keyboard), keying the PIN, or a biometric reader.

This information may be sent to the service provider in a way similar to sending the identification.

In an embodiment of the invention, confirmation may be obtained by generating an encrypted form, which ‘combines’ the transaction data and the authenticated identity. The ‘combined form’ is sometimes referred to as a digital signature. This entire sequence is also known as a “challenge-response” mechanism.

All of these identification and certification mechanisms may be carried out according to the flow chart of FIG. 4, to which reference is now made. The transaction information is transferred to the device 50 and displayed for approval (step 206). (The transaction information may also be stored in the card.) When the user types in his PIN (step 208), the card uses the transaction information and the PIN code in order to generate a digital proof, or a certificate, or alternatively, the PIN may be sent to the server to be used for certification and authentication.

The service provider (bank, for example) checks the authentication of the user/caller (query box 210), either by validating the certificate, or by verifying the provided PIN. If the signature is valid (step 212), the service provider can then allow the user/caller to proceed to order a service (step 214), such as loading e-money into the smart card, or just proceeding with the conversation with the same person in the service provider. If the certification or authentication processes fails, the service provider may perform one of several steps, such as requesting a retry to overcome errors, decline the transaction, abort the communication, or even, if authorized, disable the card (step 211).

In a further example, the smart card device may be utilized as a cash-loading banking terminal, that is, as a remote service point for loading e-money into the smart card from a bank, for example. Other applications will be described hereinbelow.

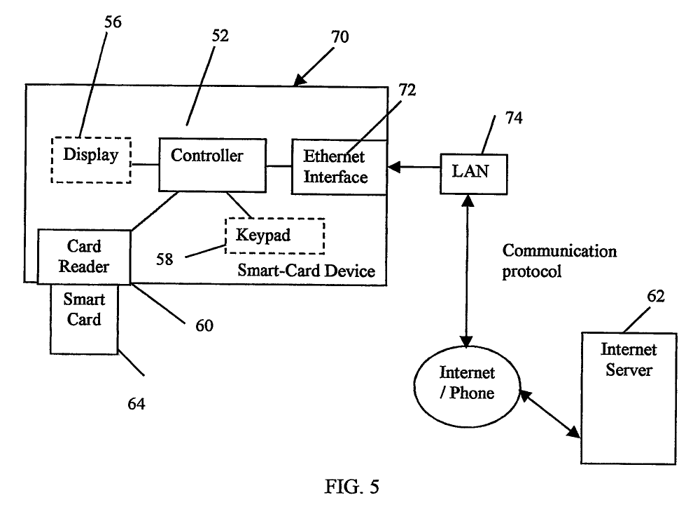

Reference is now made to FIG. 5, which is a schematic illustration of smart card device, according to another embodiment of the invention. Elements having similar functions have been designated with similar numerals and will not be described further.

FIG. 5 is a schematic illustration of a smart card device, generally designated 70, according to an embodiment of the invention. Smart card device 70 comprises a controller 52, which manages a smart card reader 60 (similar to the reader of FIG. 2), and an Ethernet interface 72 for a LAN (Local Area Network) 74. In this embodiment, the smart card device 70 is configured to utilize the Ethernet interface 72 and hook into a LAN 74, to access the Internet Server 62 directly from the device 70. The smart card 64 and the Internet server 62 can complete a client-server application over the Internet and LAN without any additional computer for mediation. The controller of the smart card device 70 simply acts as a communication enabler, establishing the link for a complete client-server configuration.

In a further embodiment of the invention, smart card device 70 may further comprise a display 56 and keyboard 58 (similar to FIG. 2). It may also contain an encryption module, such as a SIM.

The smart card device illustrated in the aforementioned embodiments may be used in many different applications, as will now be described by reference to the non-limiting exemplary applications hereinbelow.

The smart card may be used for a remote credit/debit or pre-paid transaction. This allows for carrying out secure transactions from home. In this case, the customer calls the merchant, inserts the card and the device at home and interacts directly with the POS at the merchant's shop. The merchant's POS may communicate with the credit card company to receive authorization to charge the sale. This allows for eliminating one of the common fraud means, namely Card Not Present (CNP), which mainly exists in the MOTO (mail order telephone order). By effectively presenting the card (by inserting it into the device), the merchant is assured that the customer cannot dispute the transaction. Entering the PIN in addition to the standard credit card details adds a further level of authentication, and provides a “signature” on the transaction—this “signature” may be considered to be equivalent to a hand-written signature. This turns the “card not present” transactions into a fully approved transaction, thereby preventing and reducing the level of fraud.

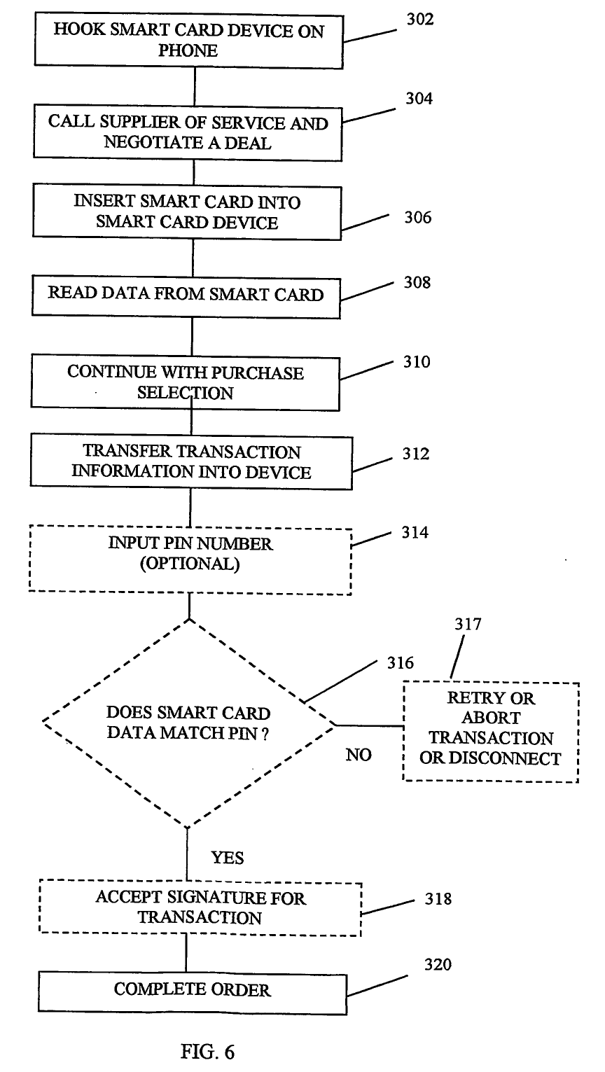

In an exemplary application, the smart card device 50 may be used for buying merchandise from a supplier over the telephone when the card is not present, that is, the card is not viewable by the supplier. The use of the smart card device allows the purchaser to effectively present and have his card verified from a remote location, as will be described with reference to the flow chart illustration of FIG. 6.

The smart card device (of FIG. 2) is hooked on a phone-cord (step 302), connecting between the phone and the wall-socket (FIG. 2a). The user selects which service to dial into (step 304), such as shopping from a call center, or food delivery (pizza etc), or call-charge. The user inserts a smart card into the smart card device (step 306) allowing the merchant to receive data relating to the user's smart card. The merchant verifies the authenticity of the smart card (step 308).

The user may activate a selected combination of keys using the numeric keyboard of the telephone or smart card device to identify a particular transaction offered by the merchant (step 310). The transaction information is transferred to the smart card device and displayed for approval (step 312). The transaction information may also be stored in the card.

The user optionally enters a personal ID (PIN) number (step 314), using device's keypad. The personal ID number (PIN) may be a merchant specific PIN number allocated to the user by the merchant, or typically, it may be the card's PIN code. The use of the PIN is optional, depending on the merchant or card-issuer's policy. There is no need to transmit PIN information over the phone, as the card performs the authentication.

The use of the PIN provides an additional verification for the merchant (step 314) and may be required, before the transaction is approved (step 310), for example if the cost of the transaction is over some threshold.

The merchant checks authenticity of the signature, using standard certificate procedures (digital signatures) of the user (query box 316) and if the signature is approved (authentication completed) (step 318), completes the sale (step 320). Otherwise, that is, if the digital signature is rejected (step 317), or if the card issuer or the “acquirer” disqualifies the card—the service may be denied (that is, the transaction is rejected), or further, the issuer may de-activate the card, using the issuer authority. This scenario may be carried out remotely from any telephone.

In an alternative application, the smart card device of the embodiment of FIG. 3 may be utilized with a cellular phone to make transactions.

In a further exemplary application, the smart card device 50 may be used for buying merchandise, using the e-money or coupons previously loaded and stored in the smart card. In this case, the card may be used for an e-cash operation (instead of as a credit/debit card) and communication is directly to the on-line server of a merchant supplying goods or services.

In a further exemplary application, the user may utilize the e-money stored on the card for ordering telephone calls that avoid the necessity of purchasing prepaid cards, for example.

In a further exemplary application, the smart card device may be used for general authentication purposes, such as authentication of the ID of a telephone caller. For example, a caller who wishes to verify his bank balance may be requested to enter his smart card and PIN number (as described hereinabove) before information is released over the telephone. The use of the smart card device thus adds a further level of user authentication. The need to enter a PIN number into the device is optional, but gives an improved level of security over existing methods, such as requesting personal information such as a passport number or mother's maiden name, information which also be known to other people. It will be appreciated by persons knowledgeable in the art that the PIN needs not be transmitted but rather may be tested by the card locally, and furthermore, all the communicated data may be encrypted as described hereinabove.

In a further application of the present invention, the smart card device may be installed at a merchant's point of sale (POS) such as a low-volume or mobile merchant's shop. In this case, the smart card device could be used as a regular credit/debit card or alternatively for e-money transactions. In this scenario, the smart card device may be in communication with the clearing-house server. This allows for removing the need for an expensive POS, as the device itself is capable of complying with payment regulations.

In a further application of the present invention, the smart card device of the present invention may be used in public transport, such as rail, bus or flights. For example, the smart card device may be used from home to order flight, rail or bus tickets and/or reserving seats. In this scenario, the user would call the transport company and purchase his tickets and/or reserve seats using his smart card inserted in the device, similar to the method described above with reference to the flow charts of FIGS. 3 and 6. The purchase may be by credit or with e-money and the purchase/reservation information would be stored in the card (e-ticket). In this case, the merchandize itself is also an electronic one, and therefore the transaction completion includes the delivery of the goods.

The transport company (bus or rail) would then verify the purchase/reservation information by reading the traveler's smart card via contact reader or RF transceiver installed on buses or at the railway station. In a similar manner, the smart card may be used in the device to obtain e-coupons from suppliers, that is, coupons having monetary value for purchase of goods.

The card authentication can be performed in several ways as described hereinabove with reference to FIGS. 4 and 6. The device is transparent to the authentication requirements, as this is carried out either by the card, or by the remote server.

The above examples and description have of course been provided only for the purpose of illustration, and are not intended to limit the invention in any way. It will be appreciated that numerous modifications, all of which fall within the scope of the present invention, exist. Rather the scope of the invention is defined by the claims that follow:

1-34. (canceled)

35. A smart card device comprising:
a controller;
a smart card reader in communication with said controller;
a communications interface coupled to said controller; and
a power source.

36. The smart card device according to claim 35, configured to be connectable to any of a) a telephone and the wall socket of a telephone line, b) a cellular phone via either of a cable and another communication interface, and c) a telephone and its handset.

37. The smart card device according to claim 35, wherein said communications interface includes any of a MODEM, an Ethernet interface, an infra-red (IR) interface, an RF interface, and audio tone capability.

38. The smart card device according to claim 35, and further comprising any of a display screen, a numeric keypad, a function key keypad, and encryption means.

39. A system for remotely verifying the identification of the user of a smart card, the system comprising:
a smart card device, comprising:
a controller;
a smart card reader in communication with said controller;
a communication network interface coupled to said controller; and
a power circuit, and
a remotely located server in communication with said communications interface comprising means for verifying the validity of the smart card being read by said smart card device and other data keyed into said device.

40. The system according to claim 39, wherein said remotely located server further comprising means for performing any of validating a certificate and generating a “challenge” and accepting the “response” for said challenge.

41. The system according to claim 39, wherein said other data comprises at least one of a personal identification number (PIN) and biometric data.

42. The system according to claim 39, wherein said remotely located server is any of an Internet server, an Interactive Voice Recognition server (IVR), and a Point Of Sale (POS) server.

43. The system according to claim 39, wherein said remotely located server further comprises means for transferring any of e-goods and e-money.

44. A method for verifying the identification of the remote user of a smart card, the method comprising the steps of:
inserting a smart card into a smart card device, said smart card device comprising:
a controller;
a smart card reader in communication with said controller;
a communications interface coupled to said controller; and
a power source;
transmitting data from the smart card, via said communications interface, to a remotely located server;
inputting privately known information into said smart card device and transmitting said proof of signature to said remotely located server; and
said remotely located server verifying that said privately known information is a valid one for the card.

45. The method according to claim 44, wherein said privately known information includes any of a personal identification number (PIN), biometric data, and other personally known information.

46. A method for remotely purchasing goods or services, the method comprising the steps of:
inserting a smart card into a smart card device, said smart card device comprising:
a controller;
a smart card reader in communication with said controller;
a communications interface coupled to said controller; and
a power source;
selecting an item to be purchased from a supplier;
transmitting data read from the smart card, via said communications interface, to a remotely located server in communication with said supplier;
said remotely located server transferring transaction information associated with the purchase to said smart card device for approval; and
storing said transaction information in said smart card.
